(19) United States
(12) Patent Application Publication
(10) Pub. No.: US 2009/0143538 A1
(43) Pub. Date: Jun. 4, 2009

(54) Silane-Coupling-Agent-Treated Silica, Preparation Method Thereof, And Vibration-Damping And Vibration-Isolating Rubber Composition Containing The Same

(75) Inventors: Yasuo Nomura, Kanagawa (JP); Susumu Takahashi, Kanagawa (JP)

Correspondence Address: HOWARD & HOWARD ATTORNEYS PLLC, 450 West Fourth Street, Royal Oak, MI, 48067, US

(73) Assignee: DOW CORNING TORAY CO., LTD., Chiyoda-ku, Tokyo, JP (JP)

(21) Appl. No.: 11/573,619

(22) PCT Filed: Aug. 9, 2005
(86) PCT No.: PCT/JP05/15029

§ 371 Date: Feb. 12, 2007

(30) Foreign Application Priority Data
Aug. 11, 2004 (JP) JP2004-234093
Aug. 11, 2004 (JP) JP2004-234095

(51) Int. Cl. C08C 19/25; C07F 7/08

(52) U.S. Cl. 525/342; 556/429

(57) ABSTRACT

A silane-coupling-agent-treated silica having a sulfur-deviation range of 50 to 200%, comprising 100 parts by mass of silica surface-treated with 1 to 50 parts by mass of a silane coupling agent represented by the following general formula (1): Y3-Si-Z-S—CO—R (wherein Y is an acetoxy group or an alkoxy group with 1 to 6 carbon atoms, Z is an alkylene group with 1 to 8 carbon atoms, and R is a hydrocarbon group with 1 to 18 carbon atoms) is disclosed. Furthermore, a vibration-damping and vibration-isolating rubber composition comprising 100 parts by mass of a raw rubber material having C—C bonds in the main chain and 1 to 200 parts of the aforementioned silane-coupling-agent-treated silica is claimed.

### TECHNICAL FIELD

The present invention relates to a silane-coupling-agent-treated silica, a method of manufacturing the aforementioned silica, a vibration-damping and vibration-isolating rubber composition, a method of preparation of the aforementioned rubber composition, vibration-damping and vibration-isolating rubber products, and a method of molding the aforementioned rubber products.

### BACKGROUND ART

Vibration energy damping technique finds wide application in building and bridge structures, industrial machines, automobiles, electric trains, other means of transportation, etc. In particular, one method for damping vibration energy is the use of products from vibration-damping and vibration-isolating rubber, e.g., for decrease of vibrations and noise transmitted from machine parts and attenuation of shocks transmitted from foundations to building structures.

It is desirable to develop such vibration-damping and vibration-isolating rubber products that will possess good vibration-damping properties, i.e., a low dynamic spring constant which is also known as dynamic stiffness, good supporting properties, i.e., high static spring constant, and low dynamic multiplication factor, i.e., a ratio of the dynamic spring constant to the static spring constant. Another requirement of vibration-damping and vibration-isolating rubber products is durability under the product operating conditions, e.g., they should have high resistance to ageing, resistance to compression set, etc. As the vibration-damping and vibration-isolating rubber products are obtained in a process that involves forming and then vulcanizing a mixture of a raw rubber material with other compounding agents, the composition should possesses good properties of formability, e.g., molding processability, extruding processability, calendaring processability and etc.

Recently, silica is more often included in the compositions of vibration-damping and vibration-isolating rubber products. The vibration-damping and vibration-isolating rubber products that contain silica are well suited for vibration-damping and vibration-isolating applications since they demonstrate improved vibration damping properties and have low dependence of modulus of elasticity on temperature.

At the same time, silica, the surface of which is hydrophilized with silanol groups, reduces wettability of the raw rubber material, and thus impairs its dispersing properties, and imparts high viscosity to the composition that contains such a raw rubber material during and after mixing. Other problems associated with hydrophilized silica are impaired mixing, kneading, and molding properties, e.g., extruding processability, calendaring processability, and etc. Furthermore, the vulcanization accelerator contained in the aforementioned rubber composition is adsorbed on the silica surface, so that eventually the effect of the vulcanization accelerator will disappear.

It was proposed to eliminate the problems inherent in the silica-containing rubber compositions, i.e., compositions for forming a vibration-isolation rubber products, by using silica in combination with a polysulfide or a similar silica coupling agent that contains sulfur in its molecule (see Unexamined Patent Application Publication (hereafter “Kokai”) JP08-059899).

However, even the coexistence of the aforementioned silica coupling agent does not provide sufficient improvement in silica's dispersion. Moreover, the presence in the composition of such a silica coupling agent allows neither sufficient decrease in viscosity, nor sufficient improvement in workability, e.g., suitability for mixing, kneading, and molding. The aforementioned rubber composition can be easily subject to scorching and, hence, to the loss of formability and storage stability. Furthermore, the above composition cannot be formed into a vulcanized rubber with a low dynamic multiplication factor, a low compression set, and a resistance to ageing.

On the other hand, an ethylene-propylene-diene type rubber (EPDM) that possesses high heat-resistant properties is a subject of study for use as a raw rubber material for manufacturing vibration-damping and vibration isolating rubber products operating in a high-temperature environment, e.g., in an engine room, or the like. However, a rubber product (vulcanized rubber) produced from such a raw rubber material as EPDM has a high dynamic multiplication factor that makes this product insufficiently suitable for vibration-damping and vibration-isolating applications and insufficiently durable. In order to solve the above problems by increasing durability and reducing the dynamic multiplication factor of rubber products obtained from the EPDM as a raw rubber material, it was proposed to prepare a rubber composition by compounding the EPDM type raw rubber material with a silica powder having a predetermined BET specific surface, a sulfur-containing silane coupling agent, and a mercapto-type silane coupling agent (see Kokai JP2003-335907 equivalent to EP 1364989 A).

However, even with introduction of those silane coupling agents, improvement in dispersity of silica is sufficient. The rubber composition disclosed in Kokai JP2003-335907 requires high processing temperature and does not possess sufficient workability because of a high Mooney viscosity. And, the vulcanized rubber obtained from the aforementioned rubber composition does not possess sufficient durability, e.g. a low compression set and high resistance to ageing.

As a method to combine a silane coupling agent with a silica-containing rubber composition, the integral blending method, in which a silane coupling agent is added to the composition during mixing and kneading the raw rubber material with silica, is generally known. When a silane coupling agent that is used in the integral blending method contains atoms of sulfur, the aforementioned atoms of sulfur contained in silane coupling agent are dispersed in the raw rubber material and thus create in the obtained composition more favorable conditions for scorching and for worsening composition properties of moldability and storage stability. If a sulfur-free silane coupling agent is used with a composition in order to prevent such scorching, as the sulfur-free silane coupling agent does not participate in the vulcanization reaction and does not cause such a reaction between the silica and the raw rubber material, the obtained vulcanized rubber cannot be produced with good general physical properties, e.g., tensile strength, elongation at rupture, and hardness.

In order to improve reactivity of a silane coupling agent during the integral blending method, generally, it is effective to increase the operation temperature during mixing and kneading. However, for protecting the raw rubber material from deterioration and for reducing consumption of energy in the production, it is desired that the operation temperature be as low as possible.

On the other hand, in order to increase productivity in the manufacture of the vulcanized rubber (a vibration-damping and vibration-isolating rubber product), the aforementioned rubber composition should possess excellent vulcanization properties, e.g., high speed of vulcanization.

### DISCLOSURE OF INVENTION

It is a first object of the invention to provide a silane-coupling-agent-treated silica that is intended for mixing and kneading with a raw rubber material in order to form a rubber composition that possesses excellent workability (e.g., mixing, kneading, and molding properties), storage stability, and vulcanization properties (e.g., high speed of vulcanization) and that, when vulcanized, is formed into a vulcanized rubber (vibration-damping and vibration-isolating rubber products) with superb vibration-damping and supporting characteristics, low compression set, and improved resistance to ageing; and to provide a method for the preparation of the aforementioned composition.

It is a second object of the invention to provide a vibration-damping and vibration-isolating rubber composition that is characterized by excellent workability (e.g., miscibility, kneadability, and moldability) and storage stability and that can be vulcanized into a vulcanized rubber of excellent vibration-damping and supporting properties with low compression set and high resistance to ageing; and to provide a method for the preparation of the aforementioned composition.

It is a third object of the invention to provide a rubber composition that can be used for forming a vulcanized rubber (vibration-damping and vibration-isolating rubber products) that has a low dynamic multiplication factor, e.g., below 1.40, at vibration-damping and vibration-isolating conditions; and to provide a method for the preparation of the above composition.

It is a fourth object of the invention to provide vibration-damping and vibration-isolating rubber products that possess excellent vibration-proof and supporting properties, low compression set, and high resistance to ageing; and to provide a method for the preparation of the above products.

It is a fifth object of the invention to provide vibration-damping and vibration-isolating rubber products that are characterized by a low dynamic multiplication factor, e.g., lower than 1.40; and to provide a method for the preparation of the above products.

As a result of diligent study aimed at achieving the above objects, the inventors herein have found that a rubber composition of excellent workability, storage stability, and with improved vulcanization properties can be produced by first obtaining a silane-coupling-agent-treated silica with a narrow sulfur deviation range by surface treating a silica with the use of a silane coupling agent having a specific structure, and then mixing and kneading the obtained silane-coupling-agent-treated silica with a raw rubber material; furthermore, by vulcanizing the prepared rubber composition, it becomes possible to produce vibration-damping and vibration-isolating rubber products with well balanced properties (e.g., vibration-damping, supporting properties, compression set, resistance to ageing, and general physical properties) that are normally required for such products.

The silane-coupling-agent-treated silica of the present invention has a sulfur-deviation range of 50 to 200% and comprises 100 parts by mass of a silica surface-treated with 1 to 50 parts by mass of a silane coupling agent (hereafter referred to as “a specific silane coupling agent”) represented by the following general formula (1): Y₃—Si-Z-S—CO—R (wherein Y is an acetoxy group or an alkoxy group with 1 to 6 carbon atoms, Z is an alkylene group with 1 to 8 carbon atoms, and R is a hydrocarbon group with 1 to 18 carbon atoms).

The vibration-damping and vibration-isolating composition of the invention is characterized by comprising 1 to 200 parts by mass of the silane-coupling-agent-treated silica of the present invention per 100 parts by mass of the raw rubber material having C—C bonds in its main molecular chain.

The following are preferred embodiments of the vibration-damping and vibration-isolating composition of the invention:

(1) The aforementioned raw rubber material comprises 20 to 100 parts by mass of a natural rubber and 80 to 0 parts by mass of a synthetic rubber.
(2) The aforementioned raw rubber material comprises 60 to 100 parts by mass of a natural rubber and 40 to 0 parts by mass of a synthetic rubber.
(3) The aforementioned raw rubber material comprises 80 to 100 parts by mass of a natural rubber and 20 to 0 parts by mass of a synthetic rubber.
(4) The aforementioned synthetic rubber is at least one type of a synthetic rubber selected from a styrene-butadiene rubber, isoprene rubber, and butadiene rubber.
(5) The aforementioned raw rubber material comprises exclusively a natural rubber.
(6) The aforementioned raw rubber material contains an EPM and/or EPDM at least 70 mass %.
(7) The aforementioned raw rubber material contains an EPM and/or EPDM at least 80 mass %.
(8) The aforementioned raw rubber material comprises exclusively an EPM and/or EPDM.
(9) The dynamic multiplication factor obtained after vulcanization does not exceed 1.40.
(10) The dynamic multiplication factor obtained after vulcanization does not exceed 1.35.
(11) The dynamic multiplication factor obtained after vulcanization does not exceed 1.30.
(12) The dynamic multiplication factor obtained after vulcanization does not exceed 1.25.

The method for the preparation of the silane-coupling-agent-treated silica of the invention consists in surface treating 100 parts by mass of silica with 1 to 50 parts by mass of the specific silane coupling agent.

The method for the preparation of the vibration-damping and vibration-isolating rubber of the invention consists in mixing and kneading 1 to 200 parts by mass of the silane-coupling-agent-treated silica of the invention with 100 parts by mass of a raw rubber material that contains C—C bonds in its main molecular chain.

The vibration-damping and vibration-isolating rubber products are obtained by vulcanizing the rubber composition of the invention. It is recommended that the vibration-damping and vibration-isolating rubber products have the dynamic multiplication factor below 1.40.

The method of the invention for the preparation of a vibration-damping and vibration-isolating rubber product comprises vulcanization of the rubber composition of the invention.

### [Effects of the Invention]

(1) Mixing of 1 to 200 by mass of the silane-coupling-agent-treated silica of the invention with 100 parts by mass of a raw rubber material that contains C—C bonds in its main molecular chain produces the rubber composition of the invention.
(2) The rubber composition of the invention has a low Mooney viscosity and possesses excellent workability (e.g., mixing and kneading properties and moldability).
(3) The rubber composition of the invention is characterized by a long Mooney scorch time along with excellent workability and storage stability.
(4) Since the rubber composition of the invention has excellent vulcanization properties, the vulcanization time is short and, therefore, allows manufacture of the vibration-damping and vibration-isolating rubber products with increased productivity.
(5) The composition of the invention can be treated at relatively low operation temperatures (e.g., the mixing and kneading temperature).
(6) Vulcanization of the rubber composition of the invention results in the formation of a vulcanized rubber (vibration-isolating and vibration-isolating rubber products) with excellent vibration-isolating and supporting properties, reduced compression set, and good resistance to ageing.
(7) Vulcanization of the rubber composition of the invention results in the formation of a vulcanized rubber (vibration-damping and vibration-isolating rubber products) with excellent general physical properties (e.g., tensile strength, elongation at rupture, and hardness).
(8) Vulcanization of the rubber composition of the present invention (according to claim 8) makes it possible to obtain a vulcanized rubber that demonstrates a low (less than 1.40) dynamic multiplication factor in vibration-damping and vibration-isolating applications.
(9) Vibration-damping and vibration-isolating rubber products of the invention possess excellent vibration-damping and supporting properties, low compression set, and high resistance to ageing.
(10) The vibration-damping and vibration-isolating rubber products of the invention have good general physical properties (e.g., tensile strength, elongation at break, and hardness).
(11) The rubber products of the present invention for vibration-damping and vibration-isolating applications (according to claim 17) have a dynamic multiplication factor not exceeding 1.40 and have a good balance between excellent vibration-damping properties (a low dynamic spring constant) and excellent supporting properties (a high static spring constant).
(12) As the vibration-damping and vibration-isolating rubber products of the invention (according to claim 16) contain a raw material with EPM and/or EPDM, they have high heat-resistant properties and good balance between such characteristics as vibration-damping properties, supporting properties, compression set, resistance to ageing, and general physical properties, even when these products are used in a high-temperature environment.
(13) The vibration-damping and vibration-isolating rubber composition of the invention is suitable for manufacturing engineering and structural materials since vulcanization of this rubber composition produces materials that are characterized by resistance to ageing, excellent resistance to compression set, small changes of viscosity in storage prior to vulcanization, a low Mooney viscosity, low processing temperature, improved resistance to scorching, short vulcanization time, highly improved workability, and superb storage stability.

### BEST MODE FOR CARRYING OUT THE INVENTION

The invention will be further described in more detail.

### [Silane-Coupling-Agent-Treated Silica]

The silane-coupling-agent-treated silica of the present invention is a silica treated with the specific silane coupling agent and has a sulfur deviation range of 50 to 200%. The silane-coupling-agent-treated silica comprises 100 parts by mass of silica and 1 to 50 parts by mass of the specific silane coupling agent.

There are no special restrictions with regard to the silica used for obtaining the silane-coupling-agent-treated silica of the present invention. This can be any conventionally used silica, such as a fumed silica, precipitated silica, fused silica, crystalline silica, spherical silica, crushed silica, etc. Furthermore, this may be a moisture-containing or dehydrated silica, but the moisture-containing silica is preferable. The silica should have a specific surface-area within the range of 5 to 400 m²/g, preferably, 10 to 300 m²/g. and even more preferably, 50 to 300 m²/g. The specific surface area of the silica can be measured by a nitrogen adsorption method (e.g., with the use of a surface-area measuring device, model SA-1000 produced by Shibata Kagakukikai Kogyo Co., Ltd.).

The specific silane coupling agent used for obtaining the silane-coupling-agent-treated silica of the present invention is expressed by below-given general formula (1): Y₃—Si-Z-S—CO—R (where Y is an acetoxy group or an alkoxy group with 1 to 6 carbon atoms, Z is an alkylene group with 1 to 8 carbon atoms, and R is a hydrocarbon group with 1 to 18 carbon atoms).

The “acetoxy or alkoxy group with 1 to 6 carbon atoms” designated in formula (1) by Y may be exemplified by methoxy, ethoxy, propoxy, isopropoxy, isobutoxy, or a similar alkoxy group; acetoxy group, etc. Of these, most preferable is an alkoxy group with 1 to 4 carbon atoms.

The “alkylene group with 1 to 8 carbon atoms” designated in formula (1) by Z, may be exemplified by a methylene group (—CH₂—), ethylene group (—CH₂CH₂—), trimethylene group (—CH₂CH₂CH₂—), tetramethylene group (—CH₂CH₂CH₂CH₂—), propylene group (—CH(CH₃)CH₂—), etc. Of these, most preferable are the ethylene group and propylene group. The “hydrocarbon group with 1 to 18 carbon atoms” designated in formula (1) by R may comprise a linear-chained, cyclic, or branch-chained alkyl group, alkenyl group, aryl group, or aralkyl group. Specific examples are the following: methyl, ethyl, propyl, isopropyl, butyl, isobutyl, t-butyl, pentyl, isopentyl, hexyl, isohexyl, heptyl, isoheptyl, octyl, isooctyl, nonyl, isononyl, decyl, isodecyl, undecyl, isoundecyl, dodecyl, isododecyl, tridecyl, isotridecyl, tetradecyl, isotetradecyl, pentadecyl, isopentadecyl, hexadecyl, isohexadecyl, heptadecyl, isoheptadecyl, octadecyl, isooctadecyl group, etc.

The following are examples of the specific silane coupling agent: 3-triethoxysilylpropyl thioacetate, 3-trimethoxysilyipropyl thioacetate, 3-tripropoxysilylpropyl thioacetate, 3-octanoylthiopropyl trimethoxysilane, 3-octanoylthiopropyl trimethoxysilane, 3-octanoylthiopropyl tripropoxysilane, 2-acetylthioethyl trimethoxysilane, etc. Most preferable is the 3-octanoylthiopropyl trimethoxysilane.

The specific silane coupling agent can be produced by a known process, e.g., by an ester-exchange reaction between an appropriate mercaptotrialkoxysilane and a thioester (see WO99/09036). The 3-octanoylthiopropyl trimethoxysilane as the most suitable specific silane coupling agent can be obtained commercially as “NXT Silane” produced by Nippon Unicar Co., Ltd.

The specific silane coupling agent should be used in an amount of 1 to 50 parts by mass, preferably, 2 to 40 parts by mass, and even more preferably, 5 to 30 parts by mass per 100 parts by mass of the silica to be treated. If the agent is used in an amount of less than aforementioned lower limit per 100 parts by mass of the silica, the effect of the invention will not be achieved. If, on the other hand, the agent is used in an amount exceeding aforementioned upper limit per 100 parts by mass of the silica, this will not noticeably improve the effect, but will be economically unjustifiable in view of a relatively high cost of this agent.

Various methods can be used for treating the surface of the silica with the specific silane coupling agent. For example, this can be a dry-system method, wet-system method. In the dry-system treatment method, the silica is loaded into a high-speed treatment apparatus having a stirring function, e.g., a Henschel mixer, and then the specific silane coupling agent is added while stirring is continued. The addition method of the specific silane coupling agent is preferable from the point of view of uniformity of treatment in surface coating silica with a specific silane coupling agent. Such methods of the addition of the specific silane coupling agent may be exemplified by a process with gradual dropwise addition of the silane coupling agent, a pulverization method, and introduction of the specific silane coupling agent in a gaseous phase. In the wet-system treatment method, the silane-coupling agent-treated silica is obtained by causing the silica to react with the specific silane coupling agent when the silica is dispersed in a solution of the aforementioned agent. If necessary, the process is accomplished by subsequent drying. There are no special restrictions with regard to the solvent suitable for the process. This may be water or an organic solvent. In a majority of cases, water, alcohol, or their mixtures are used.

For better surface-treatment effect in both the dry-system treatment method and the wet-system treatment method, it is recommended to use the specific silane coupling after pre-treatment, such as hydrolysis, condensation, etc. Furthermore, various known methods can be used for improving reactivity of hydroxyl groups on the surfaces of silica and the specific silane coupling agent. Examples of such methods are post-treatment heating and the use of an acid, alkali, or an organometallic compound, or a similar condensation catalyst. An example of an organometallic compound is one that contains tin or aluminum.

It is recommended that the silane-coupling-agent-treated silica has a sulfur deviation range of 50 to 200%, preferably, 60 to 180%, and even more preferably, 70 to 150%. In the context of the present patent application, the term “sulfur deviation range” is used as an index value for evaluating whether or not the silica is treated by means of the sulfur-containing silane coupling agent in a sufficient amount and with sufficient homogeneity. This index value is represented as a range between the maximal and minimal values of sulfur treatment indices (R₁ to R₁₀) determined with the use of below-given formulae (1) to (10).

R₁=(S₁/S_{T})×100 Numerical formula (1)

R₁=(S₂/S_{T})×100 Numerical formula (2)

R₃=(S₃/S_{T})×100 Numerical formula (3)

R₄=(S₄/S_{T})×100 Numerical formula (4)

R₅=(S₅/S_{T})×100 Numerical formula (5)

R₆=(S₆/S_{T})×100 Numerical formula (6)

R₇=(S₇/S_{T})×100 Numerical formula (7)

R₈=(S₈/S_{T})×100 Numerical formula (8)

R₉=(S₉/S_{T})×100 Numerical formula (9)

R₁₀=(S₁₀/S_{T})×100 Numerical formula (10)

In aforementioned numerical formulae (1) to (10), S₁ to S₁₀ designate the sulfur content, in mass %, measured by means of a simultaneous carbon/sulfur determination instrument in ten samples randomly selected from the silane-coupling-agent-treated silica obtained under the same conditions (i.e., from the same batch).

A theoretical sulfur content; S_{T} (in mass %) is determined by the following numerical formula:

S_{T}=[(w×f)/(100+w)]×100

where “w” is the amount of the silane coupling agent (in grams) per 100 g of the silica which is the object to be treated; and “f” is the percentage (mass %) of the sulfur in the silane coupling agent.

Sampling of the silane-coupling-agent-treated silica is carried out first by randomly taking ten 10 g samples from the silane-coupling-agent-treated silica and then taking 1 g of the aforementioned treated silica from each 10 g sample for subsequent measurements.

The rubber composition for vibration-damping and vibration-isolating applications that contains the silane-coupling-agent-treated silica which has the sulfur deviation range of 50 to 200% demonstrates a low Mooney viscosity, superb workability, can be treated at a low temperature of about from 120° C. to 140° C., is characterized by a long Mooney scorch time, and demonstrates high storage stability. Moreover, the composition has excellent vulcanization properties. Vibration-damping and vibration-isolating rubber products obtained by vulcanizing the aforementioned composition have improved vibration-damping and supporting properties, low compression set, resistance to ageing, and good general physical characteristics.

### [Rubber Composition]

The rubber composition of the invention is a composition for vibration-damping and vibration-isolating applications; more specifically, it is a non-vulcanized rubber composition for forming vibration-damping and vibration-isolating rubber products.

The rubber composition of the invention is obtained by mixing and kneading 1 to 200 parts by mass of the silane-coupling-agent-treated silica of the present invention with 100 parts by mass of the raw rubber material having C—C bonds in its main molecular chain.

### [Raw Rubber Material]

The raw rubber material for the rubber composition of the invention has C—C bonds in its main molecular chain and may comprises a natural (NR) and/or a synthetic rubber. The following are examples of the raw rubber material: natural rubber (NR), styrene butadiene rubber (SBR), isoprene rubber (IR), butadiene rubber (BR), butyl rubber (IIR), halogenated butyl rubber (X-IIR), chloroprene rubber (CR), acrylonitrile butadiene rubber (NBR), a copolymer of ethylene and propylene (EPM), a terpolymer of ethylene, propylene, and a diene (EPDM), etc. These raw rubber materials can be used individually or as a blend of two or more types. Most preferable of the above are natural rubber (NR), isoprene rubber (IR), butadiene rubber (BR), styrene butadiene rubber (SBR), a copolymer of ethylene and propylene (EPM), and a terpolymer of ethylene, propylene, and a diene (EPDM).

Molecular terminals of these raw rubber materials can be modified with a metal or an organic substance. For example, in the case of a butadiene rubber, the molecular terminals thereof can be modified with a modifying agent, such as a metal salt, e.g., tin tetrachloride, or an organic group such as a lactam compound.

A styrene butadiene rubber (SBR) suitable for the invention may comprise both solution-polymerization SBR (S-SBR) and emulsification-polymerization SBR (E-SBR), or a high-styrene rubber with the styrene content exceeding 60 mass %.

There are no special restrictions with regard to proportions of the ethylene and propylene in the EPM and of the ethylene, propylene, and diene in the EPDM. The appropriate proportion is selected so as to obtain desired final properties in the rubber composition and in the rubber product. The following are specific examples of dienes that are used in the EPDM's: 1,4-pentadiene, 1,4-hexadiene, 1,5-hexadiene, 2,5-dimethyl-1,5-hexadiene, 1,4-octadiene, 1,4-cyclohexadiene, cyclooctadiene, dicyclopentadiene, 5-ethylidene-2-norbornene, 5-butylidene-2-norbornene, 2-methallyl-5-norbornene and 2-isopropenyl-5-norbornene, etc. These dienes can be used individually or in combinations of two or more.

Among the raw material rubbers for the composition of the invention, it is recommended to use those that contain at least 20 mass %, preferably at least 60 mass %, even more preferably, at least 80 mass %, and most preferably, 100 mass % of the natural rubber (NR). In a vulcanized rubber (vibration-damping and vibration-isolating products) obtained from the aforementioned rubber composition, an increase in the contents of the natural rubber (NR) decreases the dynamic multiplication factor and compression set. The following are preferable examples of raw rubber materials that can be used in combination with the natural rubber (NR); isoprene rubber (IR), butadiene rubber (BR), styrene butadiene rubber (SBR), and EPM and/or EPDM. These raw rubber materials can be used in combination with the natural rubber (NR) or as a blend of two or more types.

Furthermore, among the raw rubber materials, it is also recommended to use those that contain at least mass %, preferably at least 70 mass %, even more preferably, at least 80 mass %, and most preferably, 100 mass % of the EPM and/or EPDM. The higher is the content of the EPM and/or EPDM, the better is the thermal stability (resistance to ageing) in the obtained vulcanized rubber (vibration-damping and vibration-isolating rubber product) produced from the rubber composition.

The use of raw rubber materials in combination with the EPM and/or EPDM makes it possible to obtain a vulcanized rubber (a vibration-damping and vibration-isolating rubber product) with a reduced dynamic multiplication factor (see below-given Practical Examples 13 and 14). The following are preferable examples of raw rubber materials that can be used in combination with the EPM and/or EPDM: natural rubber (NR), isoprene rubber (IR), butadiene rubber (BR), and styrene butadiene rubber (SBR). These raw rubber materials can be used in combination with the EPM and/or EPDM individually or as a blend of two or more types.

### [Arbitrary Components]

Within the limits not contradictory to the effect of the invention, the composition may be compounded with various additional components. Such additional components may be comprise reinforcing agents (except for silica), fillers, vulcanization agents, vulcanization accelerators, vulcanization assisting agents, vulcanization retarders (scorch retarders), anti-ageing agents, softeners, silane coupling agents (except for the aforementioned specific silane coupling agent), plasticizers, stabilizers, workability improvers, coloring agents, etc.

Reinforcing agents as arbitrary components for the composition can be represented by carbon black, calcium carbonate, talc, etc. The carbon black is preferable. The presence of the reinforcing agent improves supporting properties of the rubber products (vulcanized rubber). The reinforcing agents as arbitrary components should be used in an amount of 0 to 100 parts by mass per 100 parts by mass of the raw rubber material.

The filler material as an arbitrary additive may be represented by phenol resins, polyamide resins, high-styrene resins, or other resins; short fibers of different types, etc.

The vulcanization agent as an arbitrary additive may be represented by sulfur-type vulcanization agents, peroxide-type vulcanization agents, and oxime-type vulcanization agent.

The sulfur-type vulcanization agent may be exemplified by sulfur, insoluble sulfur, tetramethylthiuram disulfide, morpholine disulfide, etc. Most preferable is sulfur that can be added in the amount of 0.5 to 5 parts by mass per 100 parts by mass of the raw rubber material.

The peroxide-type vulcanization agent can be exemplified by dicumyl peroxide, n-butyl-4,4-bis(t-butylperoxy) valerate, t-butylcumyl peroxide, di-t-butylperoxy-diisopropyl benzene, or other peroxides.

The peroxide-type vulcanization agent should be used in amounts adjusted in accordance with the amounts of the EPM and/or EPDM used in the composition.

The oxime type vulcanization agent can be represented by p-quinone dioxime, p,p′-dibenzoylquinone dioxime, etc.

The vulcanization accelerating agent as an arbitrary additive improves effect of cross-linking (i.e., rate of vulcanization) by combining with an aforementioned vulcanization agent. The vulcanization accelerating agent can be represented by sulfenamide-type compounds, thiazole-type compounds, guanidine-type compounds, aldehyde-amine or aldehyde-ammonia type compounds, thiourea-type compounds, thiuram-type compounds, dithiocarbamic acid salts, xanthate-type compounds, etc. The vulcanization accelerating agent can be added in the amount of 0.5 to 5 parts by mass per 100 parts by mass of the raw rubber material.

The sulfenamide-type compound as a vulcanization accelerating agent can be exemplified, e.g., by N-cyclohexyl-2-benzothiazol sulfenamide, N-oxydiethylene-2-benzothiazol sulfenamide, N,N-diisopropyl-2-benzothiazol sulfenamide, etc.

The thiazol-type compounds can be exemplified, e.g., by 2-mercaptobenzothiazol, 2-(2,4-dinitrophenyl) mercaptobenzothiazol, 2-(2,6-diethyl-4-morpholinothio) benzothiazol, dibenzothiazyl disulfide, etc.

The guanidine-type compounds can be represented, e.g., by diphenyl guanidine, diorthotolyl guanidine, triphenyl guanidine, orthotolyl biguanide, diphenyl guanidinephthalate, etc.

The aldehyde-amine or aldehyde-ammonia type compounds can be exemplified, e.g., by acetoaldehyde-aniline reaction products, butylaldehyde-aniline condensation products, hexamethylene tetramine, and acetoaldehyde-ammonia reaction products, etc.

The thiourea compounds can be exemplified, e.g., by 2-mercaptoimidazoline, or similar imidazoline-type compounds, thiacarbamide, diethylthiourea, dibutylthiourea, trimethylthiourea, diorthotolylthiourea, etc.

The thiuram-type compounds may be represented, e.g., by tetramethylthiuram monosulfide, tetramethylthiuram disulfide, tetraethylthiuram disulfide, tetrabutylthiuram disulfide, pentamethylenethiuram tetrasulfide, etc.

The dithiocarbamic acid salts can be exemplifies by zinc dimethyldithiocarbamate, zinc diethyldithiocarbamate, zinc ethylphenyldithiocarbamate, zinc butylphenyl dithiocarbamate, sodium dithiocarbamate, selenium dimethyldithiocarbamate, tellurium diethyldithiocarbamate, etc.

The xanthate-type compounds can be represented, e.g., by zinc dibutyl xanthogenate.

The vulcanization assistant agents as arbitrary additives to the rubber composition of the invention may be exemplified by known compounds, e.g., metal oxides, such as zinc oxide; aliphatic acids, such as stearic acid; and amine-type compounds, such as di-n-butylamine.

The vulcanization retaders (scorch retarders) as arbitrary additives to the rubber composition of the invention may be exemplified by an anhydrous phthalic acid, N-cyclohexylthiophthalimide, etc.

The anti-ageing agents as arbitrary additives to the rubber composition of the invention may be exemplified by amine-ketone type, aromatic secondary amine type, monophenol-type, bisphenol-type, polyphenol-type, benzoimidazole-type, dithiocarbamic acid salt type, thiourea type, phosphorous-acid type, organic thio acid type, specific wax type compounds, and mixtures of the aforementioned anti-ageing agents.

The softeners as arbitrary additives to the rubber composition of the invention may be exemplified by petroleum-type softeners (e.g., Process oil, lubricating oil, paraffin, liquid paraffin, Vaseline, etc.), aliphatic-type softeners (e.g., castor oil, linseed oil, rapeseed oil, coconut oil, etc.), waxes (e.g. tall oil, factice, beeswax, carnauba wax, lanoline, etc.), linolic acid, palmitic acid, stearic acid, lauric acid, etc. The softener can be added in the amount of 1 to 200 parts, preferably, 1 to 100 parts by mass per 100 parts by mass of the raw rubber material.

The silane coupling agent (except for the aforementioned specific silane coupling agent) as arbitrary additives to the rubber composition of the invention may be exemplified by a mercaptopropyltrialkoxysilane, bistrimethyl silylpolysulfide, etc.

All aforementioned arbitrary components can be mixed and kneaded together with the indispensable components, or, if necessary, the indispensable components can be mixed with a part of the arbitrary components, and the remaining part can be added for mixing and kneading prior to vulcanization.

### [The Composition Preparation Method of the Invention]

The composition preparation method of the invention comprises the step of mixing and kneading the raw rubber material with the specific surface-treated silica. if necessary, mixing and kneading can be carried out after premixing the raw rubber material with the arbitrary components. Mixing and kneading can be carried out in a Banbury mixer, kneader, two roll mill, etc.

One example of the composition preparation method is described below.

(1) The raw rubber material, silane-coupling-agent-treated silica, and arbitrary components, except for the vulcanization agent and vulcanization accelerator, are mixed and kneaded in a sealed mixer, such as a Banbury mixer, whereby a non-vulcanized rubber composition is obtained. Mixing and kneading conditions (e.g., temperature and time) may differ with the kind of mixer. For example, when a 5-liter capacity Banbury mixer is used, the process may be carried out for 1 to 60 min. at a temperature within the range of 80 to 170° C. If the raw rubber material contains NR, preferably, the process can be carried out within the range of 80 to 150° C. to avoid decomposing the NR. Since the obtained rubber composition is free of vulcanization components, the composition may be stored as it is for a predetermined period of time.
(2) The composition obtained in Item (1) may be compounded with a vulcanization agent and mixed and kneaded for the second time to obtain a rubber composition that contains a vulcanization system. At this stage, mixing and kneading can be carried out for 5 to 60 min., preferably, 5 to 30 min., at 40 to 70° C. The obtained composition is preformed into a predetermined shape, e.g., into a sheet. This can be done with the use of a forming machine such as an extruder, calender, two roll mill, press, etc. In the case of a two roll mill, kneading and preforming can be combined into a single operation.

### [Product Manufacturing Method of the Invention]

The product manufacturing method of the invention comprises the step of vulcanization of the rubber composition of the invention, whereby the composition is formed into a vibration-damping and vibration-isolating rubber product of the invention. Conditions for vulcanization of the composition (i.e., temperature and time) may constitute 100 to 270° C. and 1 to 150 min., respectively. Vulcanization can be carried out in a metal mold or without the mold. If not using a metal mold or using a transfer-molding equipment, the forming and vulcanization can be carried out in a continuous mode. An example of a manufacturing process is feeding the rubber composition, preformed into a sheet, to a press-type vulcanization apparatus, and heating it for 1 to 150 min. at a temperature of 100 to 270° C. and at a pressure of 2 to 50 MPa. Such a treatment will result in a vibration-damping and vibration-isolating rubber product of a predetermined shape.

### [Vibration Damping and Vibration-Isolating Rubber Products of the Invention]

The vibration damping and vibration-isolating rubber products of the invention are obtained by vulcanizing the rubber composition of the invention. In addition to the vulcanized rubber obtained only from the composition of the invention, the vibration-damping and vibration-isolating rubber products of the invention may also be formed into composite products that comprise a vulcanized rubber in combination with other materials (e.g., metal).

The vibration damping and vibration-isolating rubber products (vulcanized rubber) of the invention should have the dynamic multiplication factor (i.e., a ratio of the dynamic spring constant to the static spring constant) that satisfies requirements of vibration damping and vibration-isolating applications. It is recommended to have this factor below 1.40, preferably below 1.35, and even more preferably, below 1.30, and the most preferably, below 1.25. Such a low dynamic multiplication factor can be achieved by increasing the percentage of natural rubber (NR) contained in the raw rubber material.

When the vibration damping and vibration-isolating rubber products of the invention contains the raw rubber material with the EPM and/or the EPDM, it has not only a low dynamic multiplication factor (i.e., the ratio of the dynamic spring constant to the static spring constant) and a good balance between excellent vibration-damping and supporting properties but also high resistance to heat and maintain good balance between the appropriate properties (e.g., vibration-damping properties, low post-compression residual deformation, resistance to ageing, and general physical properties) even when used in a high-temperature environment (e.g., at temperatures above 140° C.).

### PRACTICAL EXAMPLES

The invention will be further described in more detail with reference to practical examples. However, these examples should not be construed as limiting the scope of the invention.

### Practical Example 1

Dry-process treatment was carried out by loading a Henschel mixer with 500 parts by mass of silica (Nipsil ER, the product of Tosoh Silica Corporation, specific surface area=100 m²/g), and then slowly adding, while slowly stirring the silica, 55.0 g of a pulverized specific silane coupling agent in the form of 3-octanoylthiopropyl trimethoxysilane “NXT Silane” (the product of Nippon Unicar Co.; C₁₇H₃₆O₄S₁Si₁; molecular weight=364). The product was then dried for 1 hour in a vat in an explosion-proof oven at 150° C., whereby a silane-coupling-agent-treated silica of the invention was prepared. The product obtained in this example will be hereafter referred to as a “surface-treated silica A”.

The sulfur deviation range of the obtained surface-treated silica A was determined as shown below. Ten samples, 10 g each, were randomly taken from the obtained surface-treated silica A, and then 1 g of the aforementioned treated silica was taken from each 10 g sample for subsequent measurements. The sulfur content (S₁ to S₁₀) in each sample was measured by means of a simultaneous carbon/sulfur determination instrument (Model CS-444LS-type, the product of LECO corp.). The following results were obtained:

Sulfur content (S₁)=0.850%

Sulfur content (S₂)=0.890%

Sulfur content (S₃)=0.861%

Sulfur content (S₄)=0.863%

Sulfur content (S₅)=0.888%

Sulfur content (S₆)=0.853%

Sulfur content (S₇)=0.872%

Sulfur content (S₈)=0.865%

Sulfur content (S₉)=0.881%

Sulfur content (S₁₀)=0.862%

The percentage “f” (mass %) of sulfur in the specific silane coupling agent (molecular formula: C₁₇H₃₆O₄S₁Si₁; molecular weight=364) was equal to (1×32.1)/364=0.0882, and the theoretical sulfur content (S_{T}) was determined as (w×f)/(100+w)]×100=[(11.0×0.0882)/(100+11)]×100=0.874. Based on the above data, the sulfur treatment indices (R₁ to R₁₀) were determined as shown below, whereby the sulfur deviation range was obtained as 97.3 to 101.8%.

Sulfur treatment index (R₁)=(0.850/0.874)×100=97.3 (%)

Sulfur treatment index (R₂)=(0.890/0.874)×100=101.8 (%)

Sulfur treatment index (R₃)=(0.861/0.874)×100=98.5 (%)

Sulfur treatment index (R₄)=(0.863/0.874)×100=98.7 (%)

Sulfur treatment index (R₅)=(0.888/0.874)×100=101.6 (%)

Sulfur treatment index (R₆)=(0.853/0.874)×100=97.6 (%)

Sulfur treatment index (R₇)=(0.872/0.874)×100=99.8 (%)

Sulfur treatment index (R₈)=(0.865/0.874)×100=99.0 (%)

Sulfur treatment index (R₉)=(0.881/0.874)×100=100.8 (%)

Sulfur treatment index (R₁₀)=(0.862/0.874)×100=98.6 (%)

### Practical Example 2

A silane-coupling-agent-treated silica of the invention was prepared in the same manner as in Practical Example 1, with the exception that the content of the specific silane coupling agent was changed to 30.0 g and that, the drying treatment was not conducted. Hereafter the product obtained in this example will be referred to as a “surface-treated silica B”. The sulfur deviation range was determined as in Practical Example 1 and was 95. 3 to 105.2%.

### Practical Example 3

A silane-coupling-agent-treated silica of the invention was prepared in the same manner as in Practical Example 1, with the exception that the content of the specific silane coupling agent was changed to 10.0 g. Hereafter the product obtained in this example will be referred to as a “surface-treated silica C”. The sulfur deviation range of the surface-treated silica C was determined as in Practical Example 1 and was 72.3 to 145.8%.

### Practical Example 4

A silane-coupling-agent-treated silica of the invention was prepared in the same manner as in Practical Example 1, with the exception that the content of the specific silane coupling agent was changed to 150.0 g. Hereafter the product obtained in this example will be referred to as a “surface-treated silica D”. The sulfur deviation range of the surface-treated silica D was determined as in Practical Example 1 and was 99.6 to 100.8%.

### Comparative Example 1

20.0 parts by mass of silica (Nipsil ER, the product of Tosoh Silica Corporation) was loaded into a metal bowl, 3.0 parts by mass of a silane coupling agent in the form of 3-octanoylthiopropyl trimethoxysilane “NXT Silane” (the product of Nippon Unicar Co.) was slowly added, and the components were mixed for 3 min. with the use of a spatula. As a result, a silane-coupling-agent-treated silica was prepared. The product obtained in this example will be hereafter referred to as a “surface-treated silica E”.

For the surface-treated silica E, the sulfur treatment indices (R₁ to R₁₀) were determined in the same manner as in Practical Example 1. The resulting sulfur deviation range was obtained as 3.6 to 260%.

Sulfur treatment index (R₁)=3.6 (%)

Sulfur treatment index (R₂)=10.9 (%)

Sulfur treatment index (R₃)=18.6 (%)

Sulfur treatment index (R₄)=57.8 (%)

Sulfur treatment index (R₅)=88.0 (%)

Sulfur treatment index (R₆)=121 (%)

Sulfur treatment index (R₇)=150 (%)

Sulfur treatment index (R₈)=205 (%)

Sulfur treatment index (R₉)=222 (%)

Sulfur treatment index (R₁₀)=260 (%)

### Comparative Example 2

A silane-coupling-agent-treated silica was prepared in the same manner as in Practical Example 1, with the exception that the specific silane coupling agent was replaced by 55.0 g of a silane coupling agent in the form of a bis-triethoxysilylpropyl polysilfide (A-1589, the product of Nippon Unicar Co., Ltd., average sulfur number in the sulfur chain=2). Hereafter the product obtained in this example will be referred to as a “surface-treated silica F”.

The sulfur deviation range of the surface-treated silica F was determined as in Practical Example 1 and was 92.1 to 110.8%.

### Practical Example 5

A 1.7-liter Banbury mixer (Kobe Steel Co., Ltd.) was loaded with 100 parts by mass of the natural rubber (RSS-No. 1). After kneading for 30 sec., the rubber was combined, in accordance with the data of Table 1, with 10 parts by mass of the surface-treated silica A, 5 parts by mass of the petroleum type softener (Diana Process Oil NM-280, the product of Idemitsu Kosan Co., Ltd.), 5 parts by mass of zinc oxide (Zinc White Type 1), 1 part by mass of a stearic acid, and 1 part by mass of an anti-ageing agent in the form of 2,2′-methylene-bis(4-ethyl-6-butylphenol) (Nonflex EBP, the product of Seiko Kagaku Co., Ltd.). The components were mixed and kneaded. The obtained rubber composition of the invention was discharged (discharge temperature=120° C.).

The obtained composition was cooled to about 60° C. and then was combined with 2.5 parts by mass of sulfur, 1.0 part by mass of the vulcanization accelerator CBS (N-cyclohexyl-2-benzothiazol sulfonamide) (“Nocceler CZG”, the product of Ouchishinko Chemical Industrial Co., Ltd.), and 0.2 parts by mass of the vulcanization accelerator “Nocceler D”) (1,3-diphenyl guanidine, the product of Ouchishinko Chemical Industrial Co., Ltd.). The mixture was kneaded and formed into a sheet-like rubber preform (the rubber composition of the invention that contained a vulcanization system) by means of a two roll mill (steam-heated 6-inch roller with 55° C. roller temperature).

The obtained sheet-like rubber preform was subjected to press vulcanization for 30 min. at 150° C. and formed into a 2 mm-thick vulcanized rubber sheet (a vibration-damping and vibration-isolating rubber product of the invention).

An 8 mm-thick vulcanized rubber sheet was produced under the same press-vulcanization conditions (for hardness-measurement purposes).

Another specimen (29 mm diameter×12.5 mm thickness) was produced under the same press-vulcanization conditions for measuring Compression set.

Still another specimen (50 mm diameter×25 mm thickness) was produced under the same press-vulcanization conditions for measuring the dynamic and static spring constants.

### Practical Example 6

A rubber composition of the invention was prepared in the same manner as in Practical Example 5, except that, in accordance with the data of Table 1, the surface-treated silica A was replaced by 40 parts by mass of the surface-treated silica B and amount of petrochemical softener was changed to 15 parts by mass. The discharge temperature was 120° C. This composition was used for preparing vibration-damping and vibration-isolating rubber products (vulcanized rubber sheets and specimens) of the invention.

### Practical Example 7

A rubber composition of the invention was prepared in the same manner as in Practical Example 5, except that, in accordance with the data of Table 1, the surface-treated silica A was replaced by 10 parts by mass of the surface-treated silica C. The discharge temperature was 170° C. This composition was used for preparing vibration-damping and vibration-isolating rubber products (vulcanized rubber sheets and specimens) of the invention.

### Practical Example 8

A rubber composition of the invention was prepared in the same manner as in Practical Example 5, except that, in accordance with the data of Table 1, the raw rubber material comprised a rubber blend composed of 60 parts by mass of a natural rubber and 40 parts by mass of a butadiene rubber “BR01” (the product of JSR Co., Ltd.) and that 20 parts by mass of the surface-treated silica D. The discharge temperature was 120° C. This composition was used for preparing vibration-damping and vibration-isolating rubber products (vulcanized rubber sheets and specimens) of the invention.

### Practical Example 9

A rubber composition of the invention was prepared in the same manner as in Practical Example 5, except that, in accordance with the data of Table 1, the raw rubber material comprised a rubber blend composed of 80 parts by mass of a natural rubber and that 20 parts by mass of a styrenebutadiene rubber “JSR 1500” (the product of JSR Co., Ltd.) and that 20 parts by mass of the surface-treated silica A was added. The discharge temperature was 120° C. This composition was used for preparing vibration-damping and vibration-isolating rubber products (vulcanized rubber sheets and specimens) of the invention.

### Comparative Example 3

A 1.7-liter Banbury mixer (Kobe Steel Co., Ltd.) was loaded with 100 parts by mass of the natural rubber (RSS-No. 1). After kneading for 30 sec., the rubber was combined, in accordance with the data of Table 2, with 20 parts by mass of silica (Nipsil ER) (the product of Tosoh Silica Corporation), 2 parts by mass of a silane coupling agent composed of bis-triethoxysilylpropyl polysulfide “A-1589” (the product of Nippon Unicar Co., Ltd.; an average sulfur number in the sulfur chain is 2), 5 parts by mass of the petroleum type softener (Diana Process Oil NM-280, the product of Idemitsu Kosan Co., Ltd.), 5 parts by mass of zinc oxide (Zinc White Type 1), 1 part by mass of a stearic acid, and 1 part by mass of an anti-ageing agent in the form of 2,2′-methylene-bis(4-ethyl-6-butylphenol) (Nonflex EBP, the product of Seiko Kagaku Co., Ltd.). The components were mixed and kneaded. The obtained rubber composition of the invention was discharged (discharge temperature=170° C.).

The obtained composition was cooled to about 60° C. and then was combined with 2.5 parts by mass of sulfur, 1.0 part by mass of the vulcanization accelerator (“Nocceler CZG”, the product of Ouchishinko Chemical Industrial Co., Ltd.), and 0.2 parts by mass of the vulcanization accelerator “Nocceler D”). The mixture was kneaded and formed into a sheet-like rubber preform by means of a two roll mill (steam-heated 6-inch roller with 55° C. roller temperature).

The obtained sheet-like rubber preform was subjected to press vulcanization for 30 min. at 150° C. and formed into a 2 mm-thick vulcanized rubber sheet (a vibration-damping and vibration-isolating rubber product).

An 8 mm-thick vulcanized rubber sheet was produced under the same press-vulcanization conditions (for hardness-measuring purposes).

Another specimen (29 mm diameter×12.5 mm thickness) was produced under the same press-vulcanization conditions for measuring Compression set.

Still another specimen (50 mm diameter×25 mm thickness) was produced under the same press-vulcanization conditions for measuring the dynamic and static spring constants.

### Comparative Example 4

A rubber composition was prepared in the same manner as in Comparative Example 3, except that, in accordance with the data of Table 2, the silane coupling agent (“A-1589”, the product of Nippon Unicar Co., Ltd.) was replaced by 3 parts by mass of the specific silane coupling agent in the form of 3-octanoylthiopropyl trimethoxysilane (NXT silane, the product of Nippon Unicar Co., Ltd.). The discharge temperature was 170° C. This composition was used for preparing comparative vibration-damping and vibration-isolating rubber products (vulcanized rubber sheets and specimens).

### Comparative Example 5

A rubber composition was prepared in the same manner as in Comparative Example 3, except that, in accordance with the data of Table 2, the silica (Nipsil ER, the product of Tosoh Silica Corporation) was replaced by 23.0 parts by mass of the surface-treated silica E and that the silane coupling agent A-1589” (the product of Nippon Unicar Co., Ltd.) was not added. The discharge temperature was 170° C. This composition was used for preparing comparative vibration-damping and vibration-isolating rubber products (vulcanized rubber sheets and specimens).

### Comparative Example 6

A rubber composition was prepared in the same manner as in Comparative Example 3, except that, in accordance with the data of Table 2, the silica (Nipsil ER, the product of Tosoh Silica Corporation) was replaced by 10.0 parts by mass of the surface-treated silica F and that the silane coupling agent A-1589” (the product of Nippon Unicar Co., Ltd.) was not added. The discharge temperature was 170° C. This composition was used for preparing comparative vibration-damping and vibration-isolating rubber products (vulcanized rubber sheets and specimens).

### [Workability and Storage Stability]

### (1) Mooney Viscosity

The Mooney viscosity (125° C.) of all rubber compositions obtained in Practical Examples 5 to 9 and Comparative Examples 3 to 6 was measured in accordance with JIS K 6300. The results of measurements are shown in Tables 1 and 2 as an exponential factor referenced to the viscosity of the rubber composition of Comparative Example 3 as 100.

### (2) Mooney Scorch Time

The Mooney scorch time (125° C.) of all rubber compositions obtained in Practical Example 5 to 9 and Comparative Examples 3 to 6 was measured in accordance with JIS K 6300. The results of measurements are shown in Tables 1 and 2 as an exponential factor referenced to the viscosity of the rubber composition of Comparative Example 3 as 100.

(3) Time to Reach 90% Torque (t₉₀) (Index of Vulcanization Speed)

The time required to reach the 90% torque (t₉₀) at 150° C. was measured for each specimen of the rubber composition obtained in Practical Examples 5 to 9 and Comparative Examples 3 to 6. Measurements were carried out with the use of a D-type Curelastometer of JSR Co., Ltd. The results of measurements are shown in Tables 1 and 2 as an exponential factor referenced to the time (14.0 min.) measured for the rubber composition of Comparative Example 3 as 100.

### (4) Tensile Strength and Elongation (General Physical Properties)

Specimens (dumbbell specimens #3) were produced from all 2 mm-thick vulcanized rubber sheets obtained in Practical Examples 5 to 9 and Comparative Examples 3 to 6. Tensile strength (T_{B}) and elongation (E_{B}) were measured in accordance with JIS K 6251 at 25° C. and with a stretching speed of 500 mm/min. The results are shown in Tables 1 and 2.

### (5) Hardness

Hardness was measured on all 8 mm-thick vulcanized rubber sheets obtained in Practical Examples 5 to 9 and Comparative Examples 3 to 6 in accordance with JIS K 6253 (hardness by a JIS type-A hardness tester). The results of measurements are shown in Tables 1 and 2.

### (6) Static Spring Constant

Specimens (50 mm diameter×25 mm thickness) obtained in Practical Examples 5 to 9 and Comparative Examples 3 to 6 were used for measuring the static spring constant in accordance with JIS K6385. More specifically, each specimen was compressed by 7 mm by a load applied in the axial direction of a cylinder, the load was reduced, and after the specimen restored its shape, it was compressed by 7 mm by a load for the second time, a load-deformation curve was plotted, and the static spring constant (Ks) was calculated from the loads in the 1.5 to 3.5 mm range of deformations on the curve. The results are shown in Tables 1 and 2.

### (7) Dynamic Spring Constant

Specimens (50 mm diameter×25 mm thickness) obtained in Practical Examples 5 to 9 and Comparative Examples 3 to 6 were used for measuring the dynamic spring constant in accordance with JIS K6385. More specifically, each specimen was compressed by 2.5 mm in the axial direction of a cylinder, and permanent-displacement harmonic compressive vibrations having the frequency of 100 Hz and amplitude of ±0.05 mm were applied from below the specimen to its center for determining 100 Hz dynamic spring constant (Kd₁₀₀). The results are shown in Tables 1 and 2.

### (8) Dynamic Multiplication Factor

The dynamic multiplication factor (the ratio of the dynamic spring constant to the static spring constant) was determined from the value of the dynamic spring constant (Kd₁₀₀) and the static spring constant (Ks) measured on the specimens obtained in Practical Examples 5 to 9 and Comparative Examples 3 to 6. The results are shown in Tables 1 and 2.

### (9) Compression Set

The compression set was measured on all specimens (diameter 29 mm×thickness 12.5 mm) obtained in Practical Examples 5 to 9 and Comparative Examples 3 to 6 in accordance with JIS K6262 and at the following conditions: temperature=100° C.; compression degree=25%; compression time=22 hours; and room-temperature relaxation time after compression=30 min. The results are shown in Tables 1 and 2.

(10) Resistance to Ageing (Compression Set after Ageing)

This property was determined by measuring the compression set by the same method as in Item (9) above, but after the specimens obtained in Practical Examples 5 to 6 and Comparative Examples 3 to 6 (diameter 29 mm×thickness 12.5 mm) acquired heating hysteresis by heating for 300 hours at 100° C. in an oven and being held in a relaxed state at room temperature for 24 hours. The results are shown in Tables 1 and 2. The compression set was also measured on specimens obtained in Practical Examples 5 (diameter 29 mm×thickness 12.5 mm) acquired heating hysteresis by heating for 24 hours at 150° C. in an oven and being held in a relaxation state at room temperature for 24 hours. The results are shown in Table 1.

TABLE 1

| | Practical | Practical | Practical | Practical | Practical |
|---|---|---|---|---|---|
| | Example 5 | Example 6 | Example 7 | Example 8 | Example 9 |
| NR: “RSS-1” | 100 | 100 | 100 | 60 | 80 |
| BR¹⁾ | — | — | — | 40 | — |
| SBR²⁾ | — | — | — | — | 20 |
| Surface-Treated Silica A | 10 | — | — | — | 20 |
| Surface-Treated Silica B | — | 40 | — | — | — |
| Surface-Treated Silica C | — | — | 10 | — | — |
| Surface-Treated Silica D | — | — | — | 20 | — |
| Softener: “NM-280”³⁾ | 5 | 15 | 5 | 5 | 5 |
| Zinc White Type1 | 5 | 5 | 5 | 5 | 5 |
| Stearic Acid | 1 | 1 | 1 | 1 | 1 |
| Anti-Aging Agent⁴⁾ | 1 | 1 | 1 | 1 | 1 |
| Discharge Temperature [° C.] | 120 | 120 | 170 | 120 | 120 |
| Sulfur (Vulcanization Agent) | 2.5 | 2.5 | 2.5 | 2.5 | 2.5 |
| Vulcanization Accelerating Agent⁵⁾ | 1 | 1 | 1 | 1 | 1 |
| Vulcanization Accelerating Agent⁶⁾ | 0.2 | 0.2 | 0.2 | 0.2 | 0.2 |
| Mooney Viscosity [index number] | 70 | 75 | 83 | 68 | 72 |
| Mooney Scorch Time [index number] | 135 | 140 | 132 | 145 | 150 |
| Time to Reach 90% Torque (t90) [index number] | 50 | 48 | 52 | 46 | 41 |
| Tensile Strength (T_{B}) [MPa] | 23.8 | 19.2 | 22.0 | 22.8 | 21.8 |
| Elongation (E_{B}) [%] | 540 | 460 | 520 | 430 | 490 |
| Hardness [JIS Type A] | 52 | 58 | 53 | 53 | 54 |
| Static Spring Constant (Ks) [N/mm] | 450 | 478 | 445 | 470 | 480 |
| Dynamic Spring Constant (Kd₁₀₀) [N/mm] | 531 | 545 | 553 | 545 | 538 |
| Dynamic Multiplication Factor | 1.18 | 1.14 | 1.22 | 1.16 | 1.12 |
| Compression Set [%] | 30 | 34 | 33 | 33 | 32 |
| Compression Set [%] after 100° C./300 h ageing | 35 | 43 | 40 | 39 | 39 |
| Compression Set [%] after 150° C./24 h ageing | 72 | — | — | — | — |

TABLE 2

| | Comparative | Comparative | Comparative | Comparative |
|---|---|---|---|---|
| | Example 3 | Example 4 | Example 5 | Example 6 |
| NR: “RSS-1” | 100 | 100 | 100 | 100 |
| Surface-Treated Silica E | — | — | 23 | — |
| Surface-Treated Silica F | — | — | — | 10 |
| Silica⁷⁾ | 20 | 20 | — | — |
| Silane Coupling Agent⁸⁾ | 2 | — | — | — |
| Specific Silane Coupling Agent⁹⁾ | — | 3 | — | — |
| Softener: “NM-280”³⁾ | 5 | 5 | 5 | 5 |
| Zinc White Type1 | 5 | 5 | 5 | 5 |
| Stearic Acid | 1 | 1 | 1 | 1 |
| Anti-Aging Agent⁴⁾ | 1 | 1 | 1 | 1 |
| Discharge Temperature [° C.] | 170 | 170 | 170 | 170 |
| Sulfur (Vulcanization Agent) | 2.5 | 2.5 | 2.5 | 2.5 |
| Vulcanization Accelerating Agent⁵⁾ | 1 | 1 | 1 | 1 |
| Vulcanization Accelerating Agent⁶⁾ | 0.2 | 0.2 | 0.2 | 0.2 |
| Mooney Viscosity [index number] | 100 | 85 | 82 | 103 |
| Mooney Scorch Time [index number] | 100 | 94 | 98 | 105 |
| Time to Reach 90% Torque (t90) [index number] | 100 | 93 | 91 | 98 |
| Tensile Strength (T_{B}) [MPa] | 22.8 | 21.5 | 22.5 | 23.2 |
| Elongation (E_{B}) [%] | 480 | 470 | 480 | 510 |
| Hardness [JIS Type A] | 56 | 56 | 56 | 55 |
| Static Spring Constant (Ks) [N/mm] | 412 | 433 | 440 | 418 |
| Dynamic Spring Constant (Kd100) [N/mm] | 590 | 580 | 581 | 598 |
| Dynamic Multiplication Factor | 1.43 | 1.34 | 1.32 | 1.43 |
| Compression Set [%] | 46 | 34 | 33 | 45 |
| Compression Set [%] after 100° C./300 h ageing | 59 | 40 | 39 | 52 |

[Notes to TABLES 1 and 2]
^{l)}“BR01”(JSR Co., Ltd.)
²⁾“JSR 1500” (JSR Co., Ltd.)
³⁾“Diana Process Oil NM-280”, (the product of Idemitsu Kosan Co., Ltd.)
⁴⁾2,2′-methylene-bis(4-ethyl-6-butylphenol) (Nonflex EBP, the product of Seiko Kagaku Co., Ltd.)
⁵⁾N-cyclohexyl-2-benzothiazol sulfonamide “Nocceler CZG” (the product of Ouchishinko Chemical Industrial Co., Ltd.)
⁶⁾1,3-diphenyl guanidine “Nocceler D” (the product of Ouchishinko Chemical Industrial Co., Ltd.).
⁷⁾“Nipsil ER” (precipitated silica, Tosoh Silica Corporation)
⁸⁾bis-triethoxysilylpropyl polysulfide “A-1589” (the product of Nippon Unicar Co., Ltd.)
⁹⁾3-octanoylthiopropyl trimethoxysilane [NXT silane] (the product of Nippon Unicar Co., Ltd.)

The following conclusions can be made by analyzing the results shown in Tables 1 and 2.

(1) The rubber compositions obtained in Practical Examples 5 to 9 demonstrate a low Mooney viscosity, are characterized by long Mooney scorch time, and therefore resist to scorching, and possess excellent formability and storage stability.
(2) The rubber compositions obtained in Practical Examples 5 to 9 demonstrate a high speed of vulcanization and short vulcanization time.
(3) The rubber composition obtained in Practical Examples 5, 6 and in Practical Examples 8 and 9 can be prepared at a low mixing and kneading temperature (i.e., discharge temperature=120° C.).
(4) The vulcanized rubbers obtained in Practical Examples 5 to 9 have low dynamic multiplication factors (1.12 to 1.22) and therefore are suitable for vibration-damping and vibration-isolating applications.
(5) The vulcanized rubbers obtained in Practical Examples 5 to 9 have low Compression set, and therefore, the rubber products produced from such rubbers demonstrate high endurance.
(6) After ageing at 100° C. for 300 hours, the vulcanized rubbers obtained in Practical Examples 5 to 9 preserve low compression set; therefore, rubber products produced from such rubbers demonstrate high resistance to ageing.
(7) The rubber composition of Comparative Example 3 that contains the silane coupling agent (A-1589) added by the integral blending method is characterized by a high Mooney viscosity, has a short Mooney scorch time, and a low vulcanization speed. Furthermore, the vulcanized rubber of Comparative Example 3 is characterized by a high dynamic multiplication factor (1.43) and has high compression set prior and after ageing.
(8) The rubber composition of Comparative Example 4 that contains the specific silane coupling agent (NXT silane) added by the integral blending method is characterized by a short Mooney scorch time and a low vulcanization speed. Furthermore, the vulcanized rubber of Comparative Example 4 is characterized by a dynamic multiplication factor (1.34) that is higher than the dynamic multiplication factor (1.18) of the rubber obtained in Practical Example 5. Therefore, it has low vibration-damping and vibration-isolating properties.
(9) The rubber composition of Comparative Example 5 that is mixed and kneaded with the surface-treated silica E having a wide sulfur deviation range of 3.6 to 260% is characterized by a short Mooney scorch time and low vulcanization speed. The dynamic multiplication factor (1.32) of the vulcanized rubber of Comparative Example 5 is higher than the dynamic multiplication factor (1.18) of the rubber obtained in Practical Example 3. Therefore, it has low vibration-damping and vibration-isolating properties.
(10) The rubber composition of Comparative Example 6 that is mixed and kneaded with the surface-treated silica F treated with the silane coupling agent (A-1589) is characterized by a high Mooney viscosity, short Mooney scorch time, and low vulcanization speed. The dynamic multiplication factor (1.43) of the vulcanized rubber of Comparative Example 6 is high, and this rubber has high post-compression permanent deformation both prior and after ageing.

### Practical Example 10

In accordance with the data of Table 3, a 1.7-liter Banbury mixer (Kobe Steel Co., Ltd.) was loaded with 175 parts by mass of EP98 (an oil-extended EPDM, the product of JSR Co., Ltd.; oil constituent=75 phr) (100 parts by mass of EPDM), 10 parts by mass of Surface-treated silica A, 5 parts by mass of the petroleum type softener (Diana Process Oil PW-380, the product of Idemitsu Kosan Co., Ltd.), 5 parts by mass of zinc oxide (Zinc White Type 1), 1 part by mass of a stearic acid, and 1 part by mass of an anti-ageing agent in the form of 2,2′-methylene-bis(4-ethyl-6-butylphenol) (Nonflex EBP, the product of Seiko Kagaku Co., Ltd.). The components were mixed and kneaded. The obtained rubber composition of the invention was discharged (discharge temperature=140° C.).

The obtained composition was cooled to about 60° C. and then was combined with 2.0 parts by mass of sulfur, 1.0 part by mass of a vulcanization accelerator “Nocceler M-P” (the product of Ouchishinko Chemical Industrial Co., Ltd.) composed of MBT (2-mercaptobenzothiazol), 1.5 parts by mass of a vulcanization accelerator (“Nocceler CZ-G”) (the product of Ouchishinko Chemical Industrial Co., Ltd.) composed of CBS (N-cyclohexyl-2-benzothiazol-sulfenamide), 0.7 parts by mass of a vulcanization accelerator (“Nocceler TT-P”) (the product of Ouchishinko Chemical Industrial Co., Ltd.) composed of TMTD (tetramethylthiuram disulfide), 0.5 parts by mass of a vulcanization accelerator (“Nocceler TRA”) (the product of Ouchishinko Chemical Industrial Co., Ltd.) composed of DPTT (dipentamethylenethiuram tetrasulfide), and 0.5 parts by mass of a vulcanization accelerator (“Nocceler TMTE”) (the product of Ouchishinko Chemical Industrial Co., Ltd.) composed of TeEDC (diethyl dithiocarbamic acid tellurium). The mixture was kneaded and formed into a sheet-like rubber preform by means of a two roll mill (steam-heated 6-inch roller with 55° C. roller temperature).

The obtained sheet-like rubber preform was subjected to press vulcanization for 30 min. at 170° C. and formed into a 2 mm-thick vulcanized rubber sheet (a vibration-damping and vibration-isolating rubber product of the invention).

An 8 mm-thick vulcanized rubber sheet was produced under the same press-vulcanization conditions (for hardness-measuring purposes).

Another specimen (29 mm diameter×12.5 mm thickness) was produced under the same press-vulcanization conditions for measuring compression set.

Still another specimen (50 mm diameter×25 mm thickness) was produced under the same press-vulcanization conditions for measuring the dynamic and static spring constants.

### Practical Example 11

A rubber composition of the invention was prepared by mixing and kneading the components in the same manner as in Practical Example 10, except that, in accordance with the data of Table 2, the raw rubber material comprised a rubber blend composed of 140 parts by mass of EP98 (an oil-extended EPDM; the product of JSR Co., Ltd.) (80 pats by mass of EPDM) and 20 parts by mass of EP 11 (EPM; the product of JSR Co., Ltd.) was used and the surface-treated silica A was replaced with 40 parts by mass of the surface-treated silica B. The obtained rubber composition of the invention was discharged (discharge temperature=140° C.).

The obtained composition was cooled to about 60° C. and then was combined with 2.5 parts by mass of a vulcanization accelerator “VULNOC GM-P” (the product of Ouchishinko Chemical Industrial Co., Ltd.) composed of p-quinone dioxime and 8.0 parts by mass of a vulcanization accelerator PERCUMYL D-40 (the product of Nippon Oils and Fats Co., Ltd.) composed of dicumyl peroxide. The mixture was kneaded and formed into a sheet-like rubber preform (the rubber composition of the invention that contained a vulcanization system) by means of a two roll mill (steam-heated 6-inch roller with 55° C. roller temperature). This composition was used for preparing vibration-damping and vibration-isolating rubber products (vulcanized rubber sheets and specimens) of the invention.

### Practical Example 12

A rubber composition of the invention was prepared in the same manner as in Practical Example 10, except that, in accordance with the data of Table 3, the raw rubber material comprised a rubber blend composed of 122.5 parts by mass of the EP98 (an oil-extended EPDM; the product of JSR Co., Ltd.) (70 parts by mass of EPDM) and 30 parts by mass of a natural rubber (RSS-No. 1) was used and the surface-treated silica A was replaced with 10 parts by mass of the surface-treated silica C. The obtained rubber composition of the invention was discharged (discharge temperature=170° C.). This composition was used for preparing vibration-damping and vibration-isolating rubber products (vulcanized rubber sheets and specimens) of the invention.

### Practical Example 13

A rubber composition of the invention was prepared in the same manner as in Practical Example 10, except that, in accordance with the data of Table 3, the raw rubber material comprised a rubber blend composed of 140 parts by mass of the EP98 (an oil-extended EPDM; the product of JSR Co., Ltd.) (80 parts by mass of EPDM), 10 parts by mass of a styrene-butadiene rubber (JSR1500; the product of JSR Co., Ltd.), and 10 parts by mass of a butadiene rubber (BR01; the product of JSR Co., Ltd.) was used and the surface-treated silica A was replaced with 20 parts by mass of the surface-treated silica D. The obtained rubber composition of the invention was discharged (discharge temperature=140° C.). This composition was used for preparing vibration-damping and vibration-isolating rubber products (vulcanized rubber sheets and specimens) of the invention.

### Practical Example 14

A rubber composition of the invention was prepared in the same manner as in Practical Example 10, except that, in accordance with the data of Table 3, the raw rubber material comprised a rubber blend composed of 122.5 parts by mass of the EP98 (an oil-extended EPDM; the product of JSR Co., Ltd.) (70 parts by mass of EPDM), 20 parts by mass of a natural rubber (RSS-No. 1), and 10 parts by mass a styrene-butadiene rubber (JSR 1500, the product of JSR Co., Ltd.) was used and the amount of the surface-treated silica A was changed to 20 parts by mass. The obtained rubber composition of the invention was discharged (discharge temperature=140° C.). This composition was used for preparing vibration-damping and vibration-isolating rubber products (vulcanized rubber sheets and specimens) of the invention.

### Comparative Example 7

In accordance with the data of Table 4, a 1.7-liter Banbury mixer (Kobe Steel Co., Ltd.) was loaded with 175 parts by mass of EP98 (an oil-extended EPDM; the product of JSR Co., Ltd.) (100 parts by mass of EPDM), 20 parts by mass of silica (Nipsil ER; the product of Tosoh Silica Corporation), 3 parts by mass of the specific silane coupling agent in the form of 3-octanoylthiopropyl trimethoxysilane “NXT Silane” (the product of Nippon Unicar Co.; silica content was 15 mass %), 5 parts by mass of the petroleum type softener (Diana Process Oil PW-380, the product of Idemitsu Kosan Co., Ltd.), 5 parts by mass of zinc oxide (Zinc White Type 1), 1 part by mass of a stearic acid, and 1 part by mass of an anti-ageing agent (Nonflex EBP, the product of Seiko Kagaku Co., Ltd.). The components were mixed and kneaded. The obtained comparative rubber composition of the invention was discharged (discharge temperature=170° C.).

The obtained composition was cooled to about 60° C. and then was combined with 2.0 parts by mass of sulfur, 1.0 part by mass of a vulcanization accelerator (“Nocceler M-P”; the product of Ouchishinko Chemical Industrial Co., Ltd.) composed of MBT, 1.5 parts by mass of a vulcanization accelerator (“Nocceler CZ-G”; the product of Ouchishinko Chemical Industrial Co., Ltd.) composed of CBS, 0.7 parts by mass of a vulcanization accelerator (“Nocceler TT-P”; the product of Ouchishinko Chemical Industrial Co., Ltd.) composed of TMTD, 0.5 parts by mass of a vulcanization accelerator (“Nocceler TRA”; the product of Ouchishinko Chemical Industrial Co., Ltd.) composed of DPTT, and 0.5 parts by mass of a vulcanization accelerator (“Nocceler TTTE”; the product of Ouchishinko Chemical Industrial Co., Ltd.) composed of TeEDC. The mixture was kneaded and formed into a sheet-like rubber preform by means of a two roll mill (steam-heated 6-inch roller with 55° C. roller temperature).

The obtained sheet-like rubber preform was subjected to press vulcanization to form comparative vibration-damping and vibration-isolating rubber products (vulcanized rubber sheets and specimens) by the same method as in Practical Example 10, with the exception that the composition was the one obtained in this comparative example.

### Comparative Example 8

A rubber composition of the invention was prepared in the same manner as in Practical Example 10, except that, in accordance with the data of Table 4, of the surface-treated silica A was replaced with 23.0 parts by mass of surface-treated silica E. The obtained rubber composition of the invention was discharged (discharge temperature=170° C.). This composition was used for preparing vibration-damping and vibration-isolating rubber products (vulcanized rubber sheets and specimens) of the invention.

### Comparative Example 9

A rubber composition of the invention was prepared in the same manner as in Practical Example 10, except that, in accordance with the data of Table 4, of the surface-treated silica A was replaced with 10.0 parts by mass of surface-treated silica F. The obtained rubber composition of the invention was discharged (discharge temperature=170° C.). This composition was used for preparing vibration-damping and vibration-isolating rubber products (vulcanized rubber sheets and specimens) of the invention.

### [Workability and Storage Stability]

### (1) Mooney Viscosity

The Mooney viscosity (125° C.) of all rubber compositions obtained in Practical Examples 10 to 14 and Comparative Examples 7 to 9 was measured in accordance with JIS K 6300. The results of measurements are shown in Tables 5 and 6 as an exponential factor referenced to the viscosity of the rubber composition of Comparative Example 7 as 100.

### (2) Mooney Scorch Time

The Mooney scorch time (125° C.) of all rubber compositions obtained in Practical Example 5 to 9 and Comparative Examples 3 to 6 was measured in accordance with JIS K 6300. The results of measurements are shown in Tables 5 and 6 as an exponential factor referenced to the viscosity of the rubber composition of Comparative Example 7 as 100.

(3) Time to Reach 90% Torque (t₉₀) (Index of Vulcanization Speed)

The time required to reach the 90% torque (t₉₀) at 150° C. was measured for each specimen of the rubber composition obtained in Practical Examples 10 to 14 and Comparative Examples 7 to 9. Measurements were carried out with the use of a D-type Curelastometer of JSR Co., Ltd. The results of measurements are shown in Tables 5 and 6 as an exponential factor referenced to the time (14.0 min.) measured for the rubber composition of Comparative Example 7 as 100.

### (4) Tensile Strength and Elongation (General Physical Properties)

Specimens (dumbbell specimens #3) were produced from all 2 mm-thick vulcanized rubber sheets obtained in Practical Examples 10 to 14 and Comparative Examples 7 to 9. Tensile strength (T_{B}) and elongation (E_{B}) were measured in accordance with JIS K6251 at 25° C. and with a stretching speed of 500 mm/min. The results are shown in Tables 5 and 6.

### (5) Hardness

Hardness was measured on all 8 mm-thick vulcanized rubber sheets obtained in Practical Examples 10 to 14 and Comparative Examples 7 to 9 in accordance with JIS K 6253 (hardness by a JIS type-A hardness tester). The results of measurements are shown in Tables 5 and 6.

### (6) Static Spring Constant

Specimens (50 mm diameter×25 mm thickness) obtained in Practical Examples 10 to 14 and Comparative Examples 7 to 9 were used for measuring the static spring constant in accordance with JIS K6385. More specifically, each specimen was compressed by 7 mm by a load applied in the axial direction of a cylinder, the load was reduced, and after the specimen restored its shape, it was compressed by 7 mm by a load for the second time, a load-deformation curve was plotted, and the static spring constant (Ks) was calculated from the loads in the 1.5 to 3.5 mm range of deformations on the curve. The results are shown in Tables 5 and 6.

### (7) Dynamic Spring Constant

Specimens (50 mm diameter×25 mm thickness) obtained in Practical Examples 10 to 14 and Comparative Examples 7 to 9 were used for measuring the dynamic spring constant in accordance with JIS K6385. More specifically, each specimen was compressed by 2.5 mm in the axial direction of a cylinder, and permanent-displacement harmonic compressive vibrations having the frequency of 100 Hz and amplitude of ±0.05 mm were applied from below the specimen to its center for determining 100 Hz dynamic spring constant (Kd₁₀₀). The results are shown in Tables 5 and 6.

### (8) Dynamic Multiplication Factor

The dynamic multiplication factor (the ratio of the dynamic spring constant to the static spring constant) was determined from the value of the dynamic spring constant (Kd₁₀₀) and the static spring constant (Ks) measured on the specimens obtained in Practical Examples 10 to 14 and Comparative Examples 7 to 9. The results are shown in Tables 5 and 6.

### (9) Compression Set

The compression set was measured on all specimens (diameter 29 mm×thickness 12.5 mm) obtained in Practical Examples 10 to 14 and Comparative Examples 7 to 9 in accordance with JIS K6262 and at the following conditions: temperature=100° C.; compression degree=25%; compression time=22 hours; and room-temperature relaxation time after compression=30 min. The results are shown in Tables 5 and 6.

(10) Resistance to Ageing (Compression Set after Ageing)

This property was determined by measuring the compression set by the same method as in Item (9) above, but after the specimens obtained in Practical Examples 10 to 14 and Comparative Examples 7 and 9 (diameter 29 mm×thickness 12.5 mm) acquired heating hysteresis by heating for 24 hours at 150° C. in an oven and being held in a relaxation state at room temperature for 24 hours. The results are shown in Tables 5 and 6.

TABLE 3

| | Practical | Practical | Practical | Practical | Practical |
|---|---|---|---|---|---|
| | Example 10 | Example 11 | Example 12 | Example 13 | Example 14 |
| EPDM: “EP98”¹⁾ | 175 | 140 | 122.5 | 140 | 122.5 |
| (EPDM rubber component) | (100) | (80) | (70) | (80) | (70) |
| EPM: “EP11”²⁾ | — | 20 | — | — | — |
| NR: “RSS-1” | — | — | 30 | — | 20 |
| BR³⁾ | — | — | — | 20 | — |
| SBR⁴⁾ | — | — | — | — | 10 |
| Surface-Treated Silica A | 10 | — | — | — | 20 |
| Surface-Treated Silica B | — | 40 | — | — | — |
| Surface-Treated Silica C | — | — | 10 | — | — |
| Surface-Treated Silica D | — | — | — | 20 | — |
| Softener: “PW-380”⁵⁾ | 5 | 5 | 5 | 5 | 5 |
| Zinc Oxide Type1 | 5 | 5 | 5 | 5 | 5 |
| Stearic Acid | 1 | 1 | 1 | 1 | 1 |
| Anti-Aging Agent⁶⁾ | 1 | 1 | 1 | 1 | 1 |
| Discharge Temperature [° C.] | 140 | 140 | 170 | 140 | 140 |
| Sulfur (Vulcanization Agent) | 2 | — | 2 | 2 | 2 |
| p-Quinonedioxime⁷⁾ | — | 2.5 | — | — | — |
| Dicumylperoxide⁸⁾ | — | 8 | — | — | — |
| MBT⁹⁾ | 1 | — | 1 | 1 | 1 |
| CBS¹⁰⁾ | 1.5 | — | 1.5 | 1.5 | 1.5 |
| TMTD¹¹⁾ | 0.7 | — | 0.7 | 0.7 | 0.7 |
| DPTT¹²⁾ | 0.5 | — | 0.5 | 0.5 | 0.5 |
| TeEDC^{l3)} | 0.5 | — | 0.5 | 0.5 | 0.5 |

TABLE 4

| | Comparative | Comparative | Comparative |
|---|---|---|---|
| | Example 7 | Example 8 | Example 9 |
| EPDM: “EP98”¹⁾ | 175 | 175 | 175 |
| (EPDM rubber component) | (100) | (100) | (100) |
| Surface-Treated Silica E | — | 23 | — |
| Surface-Treated Silica F | — | — | 10 |
| Silica¹⁴⁾ | 20 | — | — |
| Specific Silane Coupling | 3 | | |
| Agent¹⁵⁾ | | | |
| Softener: “PW-380”⁵⁾ | 5 | 5 | 5 |
| Zinc Oxide Type1 | 5 | 5 | 5 |
| Stearic Acid | 1 | 1 | 1 |
| Anti-Aging Agent⁶⁾ | 1 | 1 | 1 |
| Discharge Temperature | 170 | 170 | 170 |
| [° C.] | | | |
| Sulfur | 2 | 2 | 2 |
| (Vulcanization Agent) | | | |
| MBT⁹⁾ | 1 | 1 | 1 |
| CBS¹⁰⁾ | 1.5 | 1.5 | 1.5 |
| TMTD¹¹⁾ | 0.7 | 0.7 | 0.7 |
| DPTT¹²⁾ | 0.5 | 0.5 | 0.5 |
| TeEDC¹³⁾ | 0.5 | 0.5 | 0.5 |

¹⁾“EPDM [EP98] (JSR Co., Ltd.) Oil-extended EPDM, oil component = 75 phr
²⁾“EPM [EP11] (JSR Co., Ltd.)
³⁾butadiene rubber [BR01](JSR Co., Ltd.)
⁴⁾styrene butadiene rubber [JSR1500] (JSR Co., Ltd.)
⁵⁾petrochemical softener (Diana Process Oil PW-380, the product of Idemitsu Kosan Co., Ltd.)
⁶⁾2,2′-methylene-bis(4-ethyl-6-butylphenol) (Nonflex EBP, the product of Seiko Kagaku Co., Ltd.)
⁷⁾vulcanization accelerator “VULNOC GM-P” (the product of Ouchishinko Chemical Industrial Co., Ltd.)
⁸⁾vulcanization accelerator “PERCUMYL D-40” (the product of Ouchishinko Chemical Industrial Co., Ltd.)
⁹⁾vulcanization accelerator prepared from 2-mercaptobenzothiazol (“Nocceler M-P”) (the product of Ouchishinko Chemical Industrial Co., Ltd.).
¹⁰⁾vulcanization accelerator prepared from N-cyclohexyl-2-benzothiazol sulfenamide “Nocceler CZ-G” (the product of Ouchishinko Chemical Industrial Co., Ltd.)
¹¹⁾vulcanization accelerator prepared from tetramethylthiuram disulfide (“Nocceler TT-P”) (the product of Ouchishinko Chemical Industrial Co., Ltd.).
¹²⁾vulcanization accelerator prepared from dipentamethylenethiuram tetrasulfide (“Nocceler TRA”) (the product of Ouchishinko Chemical Industrial Co., Ltd.).
¹³⁾vulcanization accelerator prepared from diethyl dithiocarbamic acid tellurium (“Nocceler TTTE”) (the product of Ouchishinko Chemical Industrial Co., Ltd.).
¹⁴⁾“Nipsil ER” (precipitated silica, Tosoh Silica Corporation)
¹⁵⁾3-octanoylthiopropyl trimethoxysilane [NXT silane] (the product of Nippon Unicar Co., Ltd.)

TABLE 5

| | Practical | Practical | Practical | Practical | Practical |
|---|---|---|---|---|---|
| | Example 10 | Example 11 | Example 12 | Example 13 | Example 14 |
| Mooney Viscosity [index number] | 83 | 75 | 81 | 68 | 73 |
| Mooney Scorch Time [index number] | 140 | 144 | 135 | 152 | 151 |
| Time to Reach 90% Torque (t90) [index number] | 52 | 51 | 51 | 49 | 46 |
| Tensile Strength (T_{B}) [MPa] | 17.2 | 17.6 | 21.4 | 21.2 | 21.6 |
| Elongation (E_{B}) [%] | 490 | 460 | 530 | 460 | 490 |
| Hardness [JIS Type A] | 53 | 54 | 53 | 53 | 54 |
| Static Spring Constant (Ks) [N/mm] | 490 | 510 | 515 | 492 | 491 |
| Dynamic Spring Constant (Kd₁₀₀) [N/mm] | 608 | 622 | 618 | 580 | 570 |
| Dynamic Multiplication Factor | 1.24 | 1.22 | 1.20 | 1.18 | 1.16 |
| Compression Set [%] | 12 | 13 | 20 | 18 | 19 |
| Compression Set [%] after 150° C./24 h ageing | 12 | 13 | 23 | 21 | 22 |

TABLE 6

| | Comparative | Comparative | Comparative |
|---|---|---|---|
| | Example 7 | Example 8 | Example 9 |
| Mooney Viscosity | 100 | 97 | 118 |
| [index number] | | | |
| Mooney Scorch Time | 100 | 105 | 98 |
| [index number] | | | |
| Time to Reach 90% Torque | 100 | 95 | 110 |
| (t90) [index number] | | | |
| Tensile Strength (T_{B}) | 14.3 | 15.6 | 13.8 |
| [MPa] | | | |
| Elongation (E_{B}) [%] | 450 | 450 | 410 |
| Hardness [JIS | 55 | 54 | 56 |
| Type A] | | | |
| Static Spring Constant | 461 | 453 | 580 |
| (Ks) [N/mm] | | | |
| Dynamic Spring Constant | 641 | 621 | 957 |
| (Kd₁₀₀) [N/mm] | | | |
| Dynamic Multiplication | 1.39 | 1.37 | 1.65 |
| Factor | | | |
| Compression Set [%] | 18 | 16 | 38 |
| Compression Set [%] | 23 | 20 | 45 |
| after 150° C./24 h | | | |
| ageing | | | |

The following conclusions can be made by analyzing the results shown in Tables 5 and 6.

(1) The rubber compositions obtained in Practical Examples 10 to 14 demonstrate a low Mooney viscosity, are characterized by long Mooney scorch time, and therefore resist to scorching, and possess excellent formability and storage stability.
(2) The rubber compositions obtained in Practical Examples 10 to 14 demonstrate a high speed of vulcanization and short vulcanization time.
(3) The rubber composition obtained in Practical Examples 10, 11 and in Practical Examples 13 and 14 can be prepared at a low mixing and kneading temperature (140° C.).
(4) The vulcanized rubbers obtained in Practical Examples 10 to 14 have low dynamic multiplication factors (1.16 to 1.24) and therefore are suitable for vibration-damping and vibration-isolating applications.
(5) The vulcanized rubbers obtained in Practical Examples 10 to 14 have low permanent deformation after compression, and therefore, the rubber products produced from such rubbers demonstrate high endurance.
(6) After ageing, the vulcanized rubbers obtained in Practical Examples 10 to 14 preserve low post-compression permanent deformation; therefore, rubber products produced from such rubbers demonstrate high resistance to ageing.
(7) The rubber composition of Comparative Example 7 that contains the specific silane coupling agent (NXT silane) added by the integral blending method is characterized by a high Mooney viscosity, has a short Mooney scorch time, and a low vulcanization speed. Furthermore, the vulcanized rubber of Comparative Example 7 is characterized by a dynamic multiplication factor (1.39) that is higher than the dynamic multiplication factor (1.24) of the vulcanized rubber of Practical Example 10.
(8) The rubber composition of Comparative Example 8 that is mixed and kneaded with the surface-treated silica E having a wide sulfur deviation range of 3.6 to 260% is characterized by a high Mooney viscosity, short Mooney scorch time, and low vulcanization speed. The dynamic multiplication factor (1.37) of the vulcanized rubber of Comparative Example 8 is higher than the dynamic multiplication factor (1.24) of the rubber obtained in Practical Example 10,
(9) The rubber composition of Examples 10 and 11 that contains a raw rubber material composed exclusively of a EPM and/or EPDM have high compression set irrespective of whether it is measured prior or after ageing.
(10) The rubber composition of Example 5 that contains a raw rubber material composed exclusively of a natural rubber has high compression set after ageing for 24 hours at 150° C.
(11) The rubber composition of Comparative Example 9 that is compounded with silica F surface-treated with the silane coupling agent (A-1589) is characterized by a high Mooney viscosity, short Mooney scorch time, and low speed of vulcanization. The vulcanized rubber of Comparative Example 9 has high dynamic multiplication factor (1.65), high post-compression permanent deformation prior and after ageing, and low durability (post-compression permanent deformation and resistance to ageing).

### INDUSTRIAL APPLICABILITY

The vibration-damping and vibration-isolating rubber of the invention (vulcanized rubber obtained from the rubber composition of the invention) is suitable for use in products intended to reduce vibration energy in such fields as building and bridge structures, industrial machines, means of transportation, etc.

The vibration damping and vibration-isolating rubber products of the invention containing natural rubber (NR) in the raw rubber material are most suitable for applications that require low dynamic multiplication factor.

The vibration-damping and vibration-isolating rubber products of the invention containing EPM and/or EPDM in the raw rubber material are most suitable for applications that require high resistance to ageing and reduced compression set.

1. A silane-coupling-agent-treated silica having a sulfur-deviation range of 50 to 200%, comprising 100 parts by mass of silica surface-treated with 1 to 50 parts by mass of a silane coupling agent represented by the following general formula (1): Y₃—Si-Z-S—CO—R wherein Y is an acetoxy group or an alkoxy group with 1 to 6 carbon atoms, Z is an alkylene group with 1 to 8 carbon atoms, and R is a hydrocarbon group with 1 to 18 carbon atoms.

2. The silane-coupling-agent-treated silica of claim 1, wherein said silane coupling agent is selected from the group consisting of a 3-triethoxysilylpropyl thioacetate, 3-trimethoxysilylpropyl thioacetate, 3-octanoylthiopropyl trimethoxysilane, 3-octanoylthiopropyl trimethoxysilane, 3-octanoylthiopropyl tripropoxysilane, 2-acetylthioethyl trimethoxysilane.

3. A vibration-damping and vibration-isolating rubber composition obtained by mixing and kneading 1 to 200 parts by mass of a silane-coupling-agent-treated silica having a sulfur-deviation range of 50 to 200%, comprising 100 parts by mass of silica surface-treated with 1 to 50 parts by mass of a silane coupling agent represented by the following general formula (1): Y₃—Si-Z-S—CO—R wherein Y is an acetoxy group or an alkoxy group with 1 to 6 carbon atoms, Z is an alkylene group with 1 to 8 carbon atoms, and R is a hydrocarbon group with 1 to 18 carbon atoms, per 100 parts by mass of a raw rubber material having C—C bonds in its main molecular chain.

4. The vibration-damping and vibration-isolating rubber composition of claim 3, wherein said raw rubber material is selected from the group consisting of a natural rubber (NR), styrene butadiene rubber (SBR), isoprene rubber (IR), butadiene rubber (BR), butyl rubber (IIR), halogenated butyl rubber (X-IIR), chloroprene rubber (CR), acrylonitrile butadiene rubber (NBR), a copolymer of ethylene and propylene (EPM), a terpolymer of ethylene, propylene, and a diene (EPDM).

5. The vibration-damping and vibration-isolating rubber composition of claim 3, wherein said raw rubber material comprises 20 to 100 parts by mass of a natural rubber and 80 to 0 parts by mass of a synthetic rubber.

6. The vibration-damping and vibration-isolating rubber composition of claim 5, wherein said synthetic rubber is selected from the group consisting of a styrene-butadiene rubber (SBR), an isoprene rubber (IR), a butadiene rubber (BR), a copolymer of ethylene and propylene (EPM), a terpolymer of ethylene, propylene, and a diene (EPDM).

7. The vibration-damping and vibration-isolating rubber composition of claim 3, wherein said raw rubber material contains 30 to 100 mass % of an ethylene-propylene rubber (EPM) and/or ethylene-propylene-diene rubber (EPDM).

8. The vibration-damping and vibration-isolating rubber composition of claim 3, wherein a dynamic multiplication factor after vulcanization does not exceed 1.40.

9. A method of preparing a silane-coupling-agent-treated silica having a sulfur-deviation range of 50 to 200%, comprising the step of surface treating 100 parts by mass of silica with 1 to 50 parts by mass of a silane coupling agent represented by the following general formula (1): Y₃—Si-Z-S—CO—R wherein Y is an acetoxy group or an alkoxy group with 1 to 6 carbon atoms, Z is an alkylene group with 1 to 8 carbon atoms, and R is a hydrocarbon group with 1 to 18 carbon atoms.

10. A method of preparing a rubber composition for a vibration-damping and vibration-isolating rubber comprising the step of mixing and kneading 1 to 200 parts by mass of a silane-coupling-agent-treated silica having a sulfur-deviation range of 50 to 200%, comprising 100 parts by mass of silica surface-treated with 1 to 50 parts by mass of a silane coupling agent represented by the following general formula (1): Y₃—Si-Z-S—CO—R wherein Y is an acetoxy group or an alkoxy group with 1 to 6 carbon atoms, Z is an alkylene group with 1 to 8 carbon atoms, and R is a hydrocarbon group with 1 to 18 carbon atoms, with 100 parts by mass of a raw rubber material having C—C bonds in its main molecular chain.

11. The method of preparing a vibration-damping and vibration-isolating rubber composition of claim 10, wherein said raw rubber material comprises 30 to 100 parts by mass of a natural rubber and 70 to 0 parts by mass of a synthetic rubber.

12. The method of preparing a vibration-damping and vibration-isolating rubber composition of claim 11, wherein said synthetic rubber is selected from the group consisting a styrene-butadiene rubber (SBR), an isoprene rubber (IR), a butadiene rubber (BR), a copolymer of ethylene and propylene (EPM), a terpolymer of ethylene, propylene, and a diene (EPDM).

13. The method of preparing a vibration-damping and vibration-isolating rubber composition of claim 10, wherein said raw rubber material contains 30 to 100 mass % of an ethylene-propylene rubber (EPM) and/or ethylene-propylene-diene rubber (EPDM).

14. A product of a vibration-damping and vibration-isolating rubber obtained by vulcanizing the rubber composition of claim 3.

15. A product of a vibration-damping and vibration-isolating rubber obtained by vulcanizing the rubber composition of claim 5.

16. A product of a vibration-damping and vibration-isolating rubber obtained by vulcanizing the rubber composition of claim 7.

17. A product of a vibration-damping and vibration-isolating rubber obtained by vulcanizing the rubber composition of claim 8 and having a dynamic multiplication factor not exceeding 1.40.

18. A method of manufacturing a product of a vibration-damping and vibration-isolating rubber by vulcanizing the rubber composition of claim 3.

19. The vibration-damping and vibration-isolating rubber composition of claim 5, wherein a dynamic multiplication factor after vulcanization does not exceed 1.40.

20. The vibration-damping and vibration-isolating rubber composition of claim 7, wherein a dynamic multiplication factor after vulcanization does not exceed 1.40.
